(19) United States
(12) Patent Application Publication
(10) Pub. No.: US 2023/0123986 A1
(43) Pub. Date: Apr. 20, 2023

(54) BED LIFTER

(71) Applicant: Joshua Carter, Scottsdale, AZ (US)

(72) Inventor: Joshua Carter, Scottsdale, AZ (US)

(21) Appl. No.: 17/952,117

(22) Filed: Sep. 23, 2022

Related U.S. Application Data
(60) Provisional application No. 63/247,055, filed on Sep. 22, 2021.

(51) Int. Cl. A61G 13/06

(52) U.S. Cl. CPC A61G 13/06

(57) ABSTRACT

A bed lifter is configured to be disposed on a leg of a massage table, a tattoo artist's table, or other table in order to adjust a height of the table. The bed lifter has a base with at least one bed lifter leg, and a connection device. The base has a first end and a second end. The connection device is disposed on or in the base. The bed lifter can be added to an existing table to convert the existing table into a height adjustable table.

### CROSS-REFERENCE TO RELATED APPLICATIONS

This application claims the benefit of U.S. Provisional Application Ser. No. 63/247,055, filed on Sep. 22, 2021. The entire disclosure of the above application is hereby incorporated herein by reference.

### FIELD

The present disclosure relates to bed lifting systems and, more particularly, to bed lifting systems for tables, which are commonly used by tattoo artists.

### INTRODUCTION

Tables are generally well known in the art. A person may lay on a massage table or other type of table in order to position their body properly for a tattoo artist to reach a desired tattoo location.

Certain tattoos may require hours of work for an artist. This may mean an artist is subjected to long hours in uncomfortable positions. The artist may need to hunch their shoulders and back in order to reach the desired tattoo location. Currently, massage tables and other tables used by tattoo artists are not configured to be adjustable or ergonomic.

There is a continuing need for a bed lifter configured to lift a tattoo artist's table. Desirably, the bed lifter may be added to an existing table to convert the existing table to a height adjustable table.

### SUMMARY

In concordance with the instant disclosure, a bed lifter configured to lift a tattoo artist's table, which may be added to the existing table to convert the existing table to a height adjustable table, is surprisingly discovered.

The present disclosure is related to a bed lifter and related system that addresses long term back, arm, neck, and shoulder issues in the field of tattooing due to poor posture during tattoo application. The bed lifter system may raise massage or other tables enough to allow a wrist or arm of a tattoo artist to be positioned in an optimal and adjustable way throughout the duration of applying a tattoo. Likewise, the bed lifter system may allow the tattoo artist to either sit more upright or stand while applying a tattoo. The bed lifter militates against the tattoo artist leaning, hunching, and stretching their head, neck, arm, and shoulders uncomfortably for hours on end.

In one embodiment, a bed lifter includes a connection device and a base with at least one bed lifter leg supporting the connection device. The connection device is adapted to receive and selectively secure a leg of a table at a predetermined height above a floor on which the bed lifter is disposed.

In another embodiment, bed lifter system includes a table having a plurality of legs, and the bed lifter. Each of the plurality of legs is disposed in and received by the connection device of one of the bed lifters to selectively secure the legs of the table at a predetermined height above a floor on which the bed lifters are disposed.

In a further embodiment, a method for adjusting table height includes steps of providing a table having a plurality of legs, and providing a plurality of the bed lifters. The method further includes a step of disposing each of the legs of the table within the connection device of one of the bed lifters. Further, the method includes a step of determining a predetermined height for the table. Additionally, the method includes a step of securing each of the legs of the table within one of the bed lifters at the predetermined height above a floor on which the bed lifters are disposed. The table height of the table may thereby be adjusted so as to optimize comfort for the tattoo artist in operation.

In an exemplary embodiment, a bed lifter is configured to be disposed on or under a leg of a massage table or other table in order to adjust a height of the table. The bed lifter may have a base, a bed lifter leg, and a connection device. The bed lifter leg may have a first end and a second end. The first end of the bed lifter leg may be disposed in or on the base. The second end may be adapted to receive the leg of the table. More specifically, in certain embodiments, the leg of the table may be inserted into an opening at the second end of the bed lifter leg. The connection device may be disposed on or in the bed lifter leg in any desired location. For example, the connection device may be disposed at the second end of the bed lifter leg. Alternatively, the connection device may be disposed more centrally on the bed lifter leg.

The bed lifter may be configured to raise the height of the table by up to twelve inches (12″) or more. In certain embodiments, a majority of the increased height may be accomplished through the base of the bed lifter. The bed lifter leg, according to certain embodiments, may provide additional, adjustable increases in height above a top portion of the base, as needed. In certain embodiments the height of the table may be adjustable along a length of the bed lifter leg only, and in certain embodiments the height of the table may be adjustable along the length of the bed lifter leg and a length of the base.

In certain embodiments, the bed lifter leg may be a hollow beam having at least two side walls. The bed lifter leg may have a square cross section, as a non-limiting example. The at least two side walls may include a first side wall and a second side wall, which may be parallel to each other. In certain embodiments, at least one of the first and second side wall of the bed lifter leg may include an aperture or opening through which the connection device may be inserted. In an alternative embodiment, the first and second side walls may have a plurality of corresponding openings formed therein.

The base may be formed by a plurality of support beams. The support beams may be fastened together with, as a non-limiting example, bolts. A skilled artisan may select any suitable means for connecting the plurality of support beams, as desired.

The support beams may be configured such that the base has a substantially trapezoidal cross section. In other words, a bottom portion or bottom end of the base may relatively larger than a top portion or top end of the base. Advantageously, the relative sizes of the top portion and bottom portion of the base provide additional support for the table. The base may have one or more rubber bottoms. Advantageously, the one or more rubber bottoms may militate against the bed lifter moving undesirably during use. A skilled artisan may select any suitable size and materials for the base, as desired.

The top portion of the base may be a solid surface on which the bed lifter leg is disposed. Alternatively, the top portion of the base may have an aperture formed therein through which the bed lifter leg may extend.

In certain embodiments, the aperture may receive a sleeve. The sleeve may have a first side wall and a second side wall, which may be disposed parallel to each other. Each of the first side wall and second side wall may have a corresponding opening. The sleeve may receive the bed lifter leg, in operation. The top portion of the base may be integral with or removably or permanently attached to the support beams, as determined by one of skill in the art.

In yet other embodiments, the openings in the first and second side wall of the bed lifter leg correspond to the openings in the first and second sidewall of the sleeve. Accordingly, when the bed lifter leg is disposed in the sleeve, the openings of the bed lifter leg are configured to align with the openings in the base. When the openings are aligned, a pin may be disposed through all four openings. In other words, the pin will pass through the opening on the first side wall of the sleeve, then the first side wall of the bed lifter leg, through the opening in the second side wall of the bed lifter leg, and out the opening in the second side of the sleeve.

The connection device, according to certain embodiments may be a thumb screw or any other suitable connecting means. In certain embodiments, the connection device may be a screw that is inserted through the opening of the first side wall of the bed lifter leg. The connection device may have a first end including a knob or other rotating mechanism and a second end including a rubber stopper or other locking mechanism capable of forming a friction fit with, or otherwise locking in place, the leg of the table.

In operation, the height of the table may be adjusted by a user using the bed lifter. In certain embodiments, the user may adjust the vertical displacement of the leg of the table within the bed lifter leg, until the desired height is reached. The user may then place the connection device through the opening in the side wall of the bed lifter leg in order to secure the leg of the table at the desired height. The leg of the table may be secured by forming a friction fit between the leg of the table and the locking mechanism, as well as between the leg of the table and the bed lifter leg. Any locking mechanism capable of securing the leg of the table within the bed lifter leg at the desired height may be used. The user may adjust a horizontal displacement of the locking mechanism within the bed lifter leg by making adjustments to the connection device using the knob or other rotating mechanism.

According to other embodiments, the user may adjust the vertical displacement of the bed lifter leg in the sleeve until the desired height is reached during use. The user may then dispose the pin through the openings to secure the bed lifter leg at the desired height.

It should be appreciated that the pin, the openings in the bed lifter leg, and the openings in the sleeve may all interact in a way that secures the bed lifter leg in the sleeve. The pin may militate against the bed lifter leg from sliding undesirably in the sleeve. Advantageously, the pin and various openings are configured to provide stability to the table while it is secured in the bed lifter.

In yet other embodiments, the connection device may be disposed on the second end of the bed lifter leg. The connection device may be configured to receive one leg from the table. The connection device may have a sleeve with a locking mechanism configured to secure the leg of the table in place.

The locking mechanism may include a pair of adjustable discs. The discs may be adjusted by the used through a pair of handles, each of the pair of handles connected to one of the discs.

In operation, the user may adjust each of the handles, which thereby adjusts a horizontal displacement of the discs. Each of the discs may be adjusted until there is sufficient tension between each of the discs and the table leg. A skilled artisan may select any suitable locking mechanism for adjustably securing the table leg in the bed lifter, as desired.

In yet additional embodiments, a bed lifter system may include four bed lifters with each of the bed lifters configured to be disposed on each one of the table legs. The height of each bed lifter and/or the leg of the table relative to the bed lifter may be individually adjusted as described hereinabove, as desired by the tattoo artist.

It should be appreciated that the locking mechanism provides an adjustable means for securing the table leg within the bed lifter. Advantageously, the locking mechanism allows a user to insert table legs of various sizes into the bed lifter. The locking mechanism, therefore, may be utilized with a variety of tables, as desired.

It should also be appreciated that the bed lifter system may be made from any strong, durable material, as desired. In certain embodiments, at least a portion of the bed lifter system may be made using sheet metal components made from 12 ga carbon steel.

Further areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described hereafter.

FIG. 1 is a front perspective view of a bed lifter according to one embodiment of the present disclosure;

FIG. 2 is a front elevational view of the bed lifter as shown in FIG. 1;

FIG. 3 is a right side elevational view thereof;

FIG. 4 is a top plan view thereof;

FIG. 5 is a rear elevational view thereof;

FIG. 6 is a left side elevational view thereof;

FIG. 7 is a bottom plan view thereof;

FIG. 8 is front perspective view showing a plurality of the bed lifters as shown in FIG. 1, further depicted in use attached to a table;

FIG. 9 is a top plan view of a preformed stamped main body from which the bed lifter shown in FIGS. 1-8 may be formed, according to one embodiment of the present disclosure; and

FIG. 10 is a flow diagram illustrating a method for adjusting a height of a table using the bed lifter shown in FIGS. 1-8, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise.

The terms “a” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

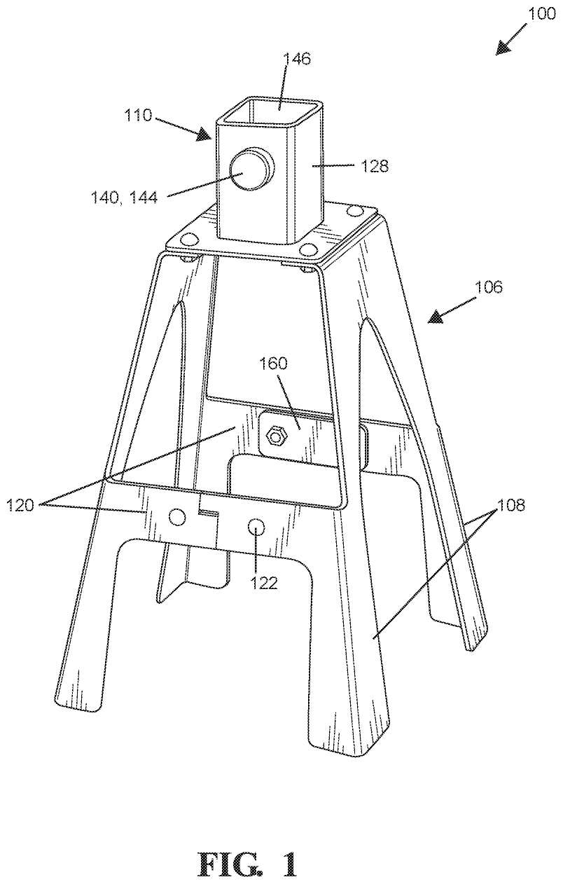

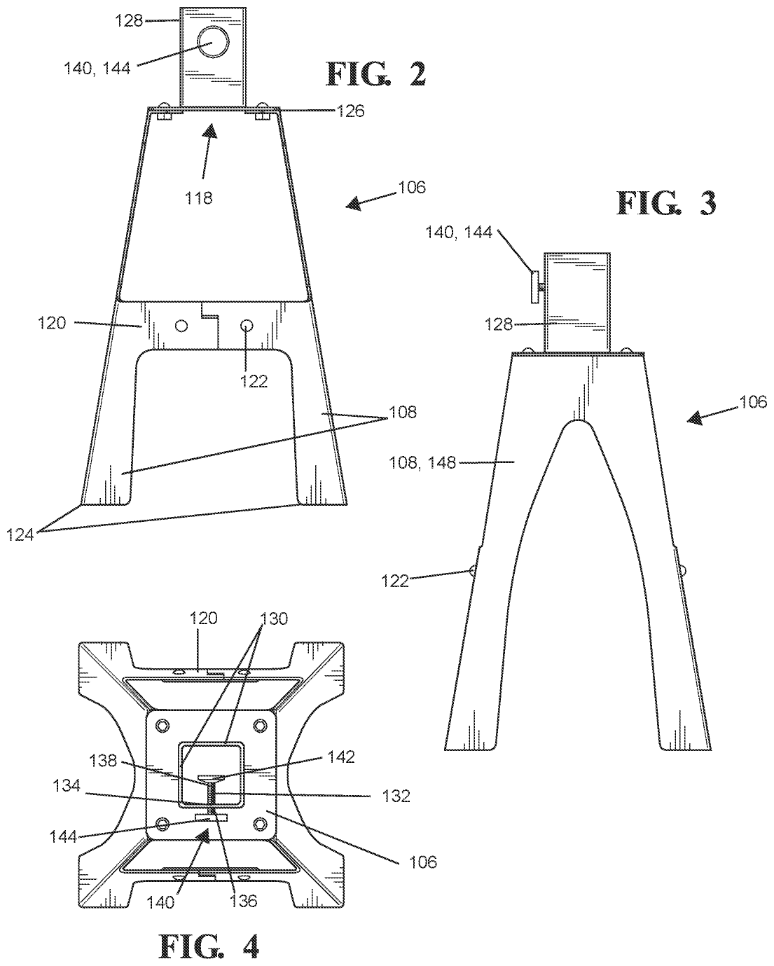

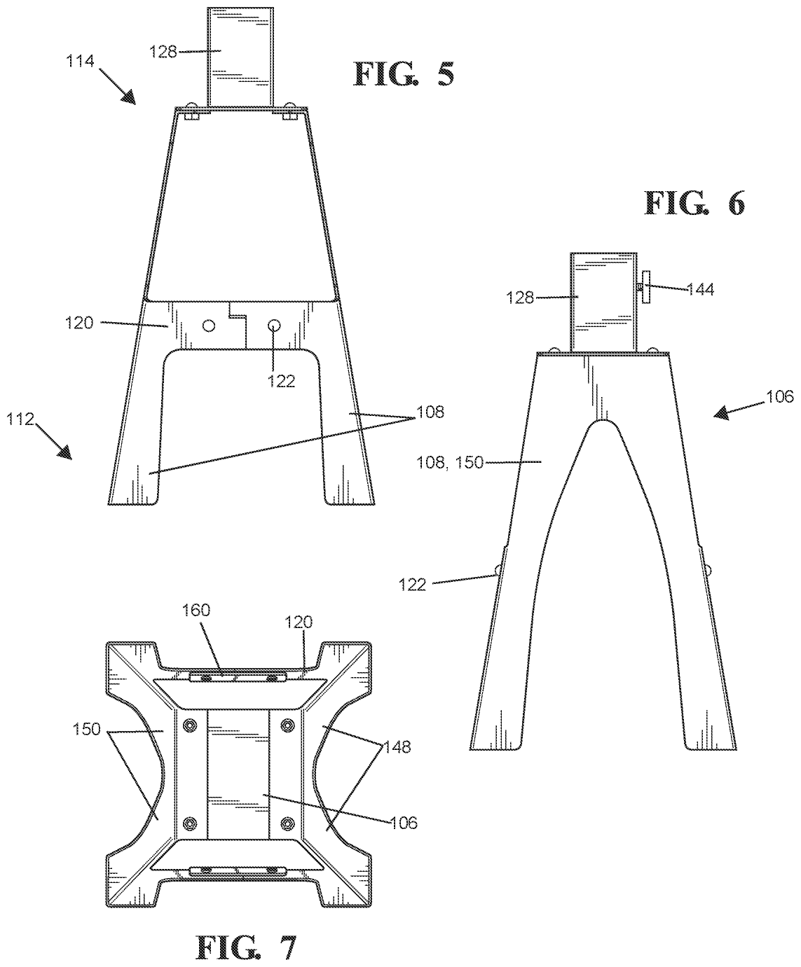

With reference to FIGS. 1-8, a bed lifter 100 according to various embodiments of the present disclosure is shown. The bed lifter 100 is configured to be disposed on or under a leg 102 of a table 104 such as a massage table, tattoo artist's table, or other table in order to adjust a height of the table 104 to a predetermined height above a floor surface. The bed lifter 100 may have a base 106, at least one bed lifter leg 108, and a connection device 110.

It should be appreciated that the bed lifter 100 of the present disclosure may be made from any strong, durable material, as desired. In certain embodiments, at least a portion of the bed lifter 100 may be made using sheet metal components made from 12 ga carbon steel. In other embodiments, the bed lifter 100 may be formed by injection molding of durable thermoplastic or composite materials. Any other suitable type of material and manufacturing process may be employed by one of ordinary skill in the art within the scope of the present disclosure.

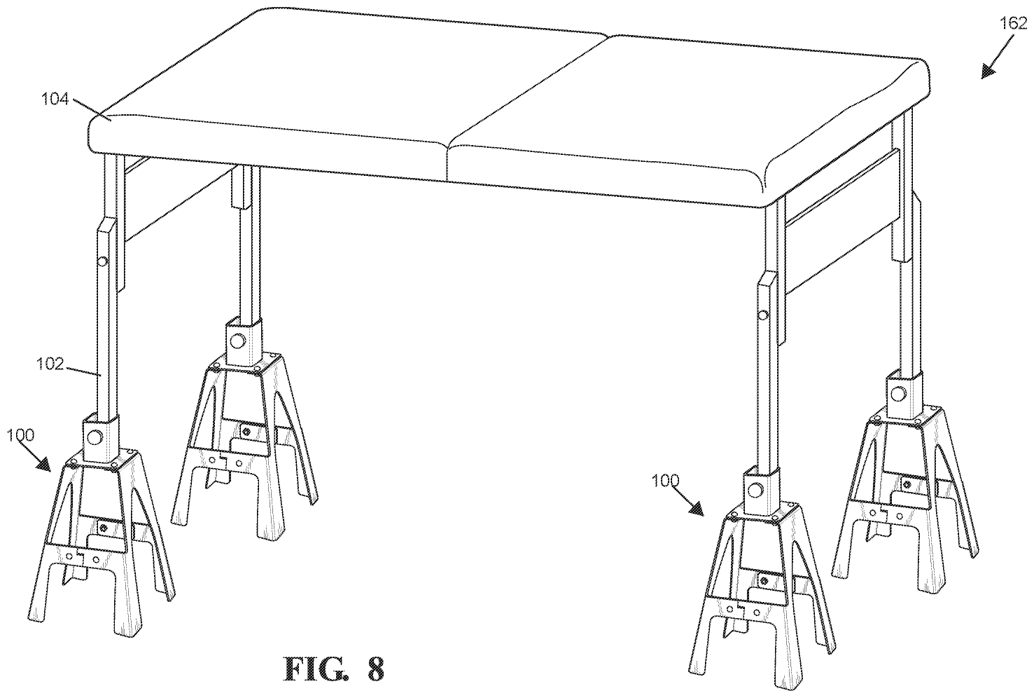

In a particular example, as shown in FIG. 1, the base 106 may have the at least one bed lifter leg 108, and together may support the connection device 110. Each of the bed lifter legs 108 may have a first end 112 and a second end 114. The first end 112 of the bed lifter leg 108 may attached to the connection device 110. The second end 114 is adapted to rest upon a floor or other surface on which the table 104 is located, for example, as shown in FIG. 8.

In certain examples, as shown in FIGS. 4, and 8 the connection device 110 may be adapted to receive the leg 102 of the table 104. More specifically, the leg 102 of the table 104 may be inserted into an opening at the second end 114 of the bed lifter leg 108. The connection device 110 may be disposed on or in the bed lifter leg 108 in any desired location. For example, as shown in FIGS. 1-8, the connection device 110 of the bed lifter 100 is disposed centrally on the base 106. In alternative examples (not shown), the connection device 110 may be disposed at the second end of the bed lifter leg 114. Other suitable locations for the connection device 110 may also be employed by one skilled in the art, as desired.

In most particular examples, as shown in FIG. 1 the connection device includes a hollow sleeve 128 and a locking mechanism 140. The locking mechanism 140 is adapted to secure the leg 102 of the table 104 within the hollow sleeve 128. For example, the locking mechanism 140 may be one of a screw, a pin, and a pair of adjustable discs, as further described herein. One of ordinary skill in the art may also select other suitable types of locking mechanisms with the scope of the present disclosure.

With reference to FIGS. 1 and 4, the hollow sleeve 128 may have a threaded hole 134 disposed therethrough. In such examples, the locking mechanism 140 may likewise be provided in the form of the screw having a threaded shaft 132 with a first end 136 and a second end 138. The threaded shaft 132 may be disposed through the threaded hole 134. The first end 136 may have a knob 144 disposed thereon. The second end 138 may have a stopper 142 disposed thereon. The stopper 142 may be formed from a resilient material such as rubber, although other suitable materials may also be used. It should be appreciated that the rotation of the knob 144 may cause the threaded shaft 132 to advance through the threaded hole 134, and cause the rubber stopper 142 to move toward or away from an inner surface 146 of the hollow sleeve 128, as desired.

In operation, as shown in FIG. 8, the screw may thereby be configured to compress the leg 102 of the table 104 between the rubber stopper 142 and the inner surface 146 of the hollow sleeve 128 of the connection device 110. This operation serves to removably secure the leg 102 of the table 104 at the predetermined height above the floor.

In most particular examples, the bed lifter 100 may be configured to raise the height of the table 104 by up to twelve inches (12″) or more. Typically, a majority of the increased height may be accomplished through the base 106 of the bed lifter 100, as shown in FIGS. 1-8. The bed lifter legs 108 themselves, according to certain example (not shown), may also be provided with adjustable features, e.g., telescopic portions, which can provide additional, adjustable increases in height above a top portion of the base 106, as needed.

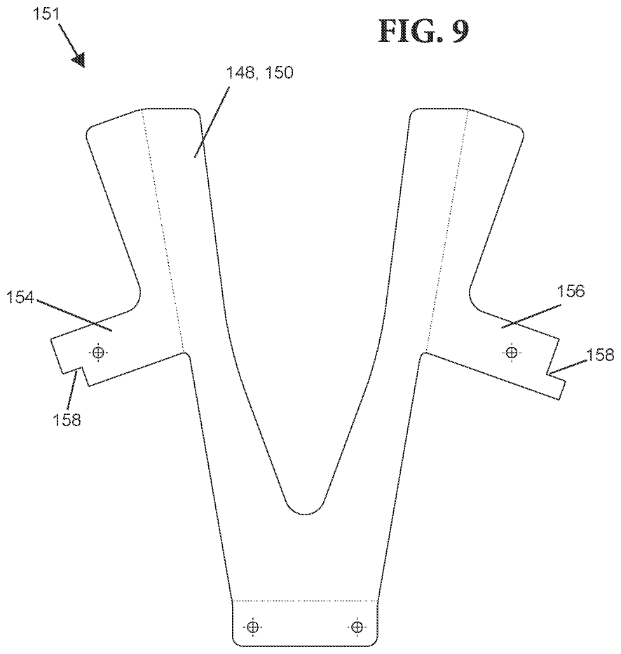

With renewed reference to FIG. 1, the at least one bed lifter leg 108 may include a plurality of bed lifter legs 108. For example, the plurality of lifter legs 108 may include a first pair of lifter legs 148 (shown in FIG. 3 and FIG. 9) and a second pair of lifter legs 150 (shown in FIG. 6 and FIG. 9). The first pair of lifter legs 148 and the second pair of lifter legs 150 may be connected by a pair of bridge elements 120, also known as “support beams.” The pair of bridge elements 120 are adapted to enhance a rigidity of the bed lifter 100 in operation.

Referring now to FIG. 9, in certain examples each of the first pair of lifter legs 148 and the second pair of lifter legs 150 is preformed as a stamped main body 151 with a partial set 154, 156 of the bridge elements 120. For example, the partial set 154, 156 of the bridge elements 120 may be bent at an angle transverse to the stamped main body 151, as shown in FIG. 1, of each of the first pair of lifter legs 148 and the second pair of lifter legs 150.

Further, as shown in FIG. 9, the partial set 154, 156 of the bridge elements 120 may each have stepped terminal ends 158. The stepped terminal ends 158 of the partial set 154, 156 of the bridge elements 120 of the first pair of lifter legs 148 may interlock with the stepped terminal ends 158 of the partial set 154, 156 of the bridge elements 120 of the second pair of lifter legs 150 to define the pair of bridge elements 120 upon assembly of the bed lifter 100 of the present disclosure.

As illustrated in FIG. 1, the partial set 154, 156 of the bridge elements 120 of the first pair of lifter legs 148 may be affixed to the partial set 154, 156 of the bridge elements 120 of the second pair of lifter legs 150 with connecting plates 160. For example, the connecting plates 160 may be affixed to the bridge elements 120 with mechanical fasteners. The mechanical fasteners can be one of bolts, screws, and rivets, as non-limiting examples. A skilled artisan can also select other types of mechanical fasteners for affixing the connecting plates 160 to the bridge elements 120, within the scope of the present disclosure.

The bridge elements 120 may be configured such that the base 106 has a substantially trapezoidal cross section. In other words, the bottom portion 124 or bottom end of the base 106 may be relatively larger than the top portion 126 or top end of the base. Advantageously, the relative sizes of the top portion 126 and the bottom portion 124 of the base provide additional support for the table 104. The base 106 may further have one or more rubberized bottoms (not shown). Advantageously, the one or more rubberized bottoms may militate against the bed lifter moving undesirably during use. A skilled artisan may select any suitable size and materials for the base, as desired.

In certain embodiments, as shown in FIGS. 1-8, the top portion 126 of the base 106 may be a solid surface integral with the hollow sleeve 128 able to receive the table leg 102. The sleeve 128 may have opposing sidewalls 130, which may be disposed parallel to each other, as shown in FIG. 1. Alternatively, a skilled artisan may select any other suitable sleeve shape to receive the legs 102 of the table 104, as desired.

It should be appreciated that the top portion 126 of the base 106 may be provided as either a solid surface on which the bed lifter leg is disposed, or the top portion 126 of the base 106 may have the opening 118 formed therethrough (as shown in FIG. 4). Where the opening 118 is provided as part of the base 106, it should be appreciated that the leg 102 of the table 104 may extend therethrough, in operation, which can provide for an additional adjustability in the predetermine height relative to the floor.

Referring now to FIG. 8, the present disclosure further includes a bed lifter system 162 or assembly, which includes the table 104 having the plurality of legs 102, and a plurality of the bed lifters 100 as described hereinabove. In the system 162, each of the plurality of legs 102 is disposed in and received by the connection device 110 of one of the bed lifters 100 to selectively secure the legs 102 of the table 104 at the predetermined height above the floor on which the bed lifters 100 are disposed.

In particular, the bed lifter system 162 may include four (4) of the bed lifters 100, with each of the bed lifters 100 configured to be disposed on each one of the legs 102 of the table 104. The height of each of the bed lifters 100 and/or the legs 102 of the table 104 relative to the bed lifters 100 may be individually adjusted as described hereinabove, for example, as desired by the tattoo artist to maximize comfort.

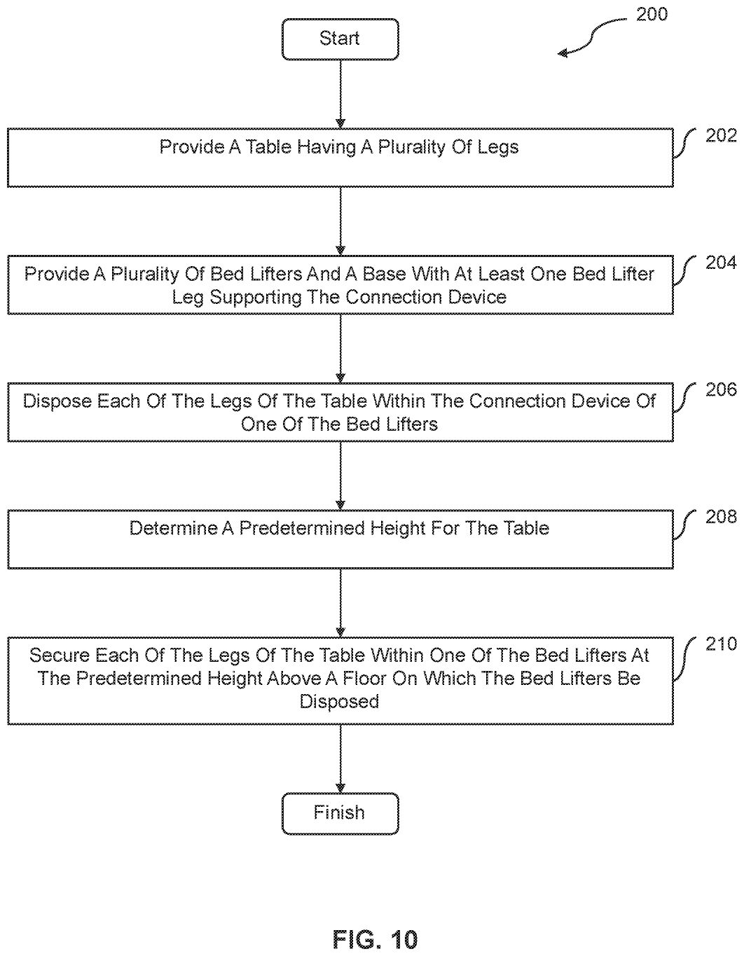

With reference to FIG. 10, the present disclosure also includes a method 200 for adjusting table height. The method 200 includes a first step 202 of providing the table 104 having the plurality of legs 102. The method 200 also includes a second step 204 of providing the plurality of bed lifters 100. Then, the method 200 includes a third step 206 of disposing each of the legs 102 of the table 104 within the connection device 110 of one of the bed lifters 100. Next, the method 200 includes a fourth step 208 of determining the predetermined height for the table 104. The method 200 also includes a fifth step 210 securing each of the legs 102 of the table 104 within one of the bed lifters 100 at the predetermined height above the floor on which the bed lifters 100 are disposed.

In operation, and employing the method 200 of the present disclosure, the height of the table 104 may be adjusted by a user using the bed lifter 100. In certain embodiments, the user may adjust the vertical displacement of the leg 102 of the table 104 within the bed lifter 100, as shown in FIGS. 1-8, until the desired height is reached. The user may then secure the leg 102 of the table 104 at the desired height using the connection device 110. The leg 102 of the table 104 may be secured by forming a friction fit between the leg 102 of the table 104 and the locking mechanism 140, for example, as well as between the leg 102 of the table 104 and the bed lifter sleeve 128, for example, via a compression of the leg 102 between the locking mechanism 140 and the inner surface 146 of the hollow sleeve 128, as shown in FIG. 8. The user may further adjust a horizontal displacement of the locking mechanism 140 within the bed lifter sleeve 128 by making adjustments to the connection device 110 using the knob or other rotating mechanism 140.

Although the employment of the screw mechanism as described hereinabove as the locking mechanism 140 has been described and may be particularly suitable, it should be appreciated that any other suitable type of the locking mechanism 140 capable of securing the leg 102 of the table 104 within the bed lifter sleeve 128 at the desired or predetermined height may also be used.

It should be appreciated that the locking mechanism 140 provides an adjustable means for securing the leg 102 of the table 104 within the bed lifter 100. Advantageously, the locking mechanism 140 allows a user to insert table legs 102 of various sizes into the bed lifter 100. The locking mechanism 140, therefore, may be utilized with a variety of tables, as desired.

Advantageously, the bed lifter 100 of the present disclosure may be configured to lift a massage table 104, a tattoo artist's table 104, or any other suitable table 104. Further, the bed lifter 100 may be added to an existing table 104 to convert the existing table 104 into a height adjustable table 104.

While certain representative embodiments and details have been shown for purposes of illustrating the invention, it will be apparent to those skilled in the art that various changes may be made without departing from the scope of the disclosure, which is further described in the following appended claims.

What is claimed is:

1. A bed lifter, comprising:
a connection device; and
a base with at least one bed lifter leg supporting the connection device,
wherein the connection device adapted to receive and selectively secure a leg of a table at a predetermined height above a floor on which the bed lifter is disposed.

2. The bed lifter of claim 1, wherein the connection device is disposed centrally on the base.

3. The bed lifter of claim 2, wherein the connection device includes a hollow sleeve and a locking mechanism, the locking mechanism adapted to secure the leg of the table within the hollow sleeve.

4. The bed lifter of claim 3, wherein the locking mechanism is one of a screw, a pin, and a pair of adjustable discs.

5. The bed lifter of claim 4, wherein the hollow sleeve has a threaded hole disposed therethrough, and the locking mechanism is the screw having a threaded shaft with a first end and a second end, the threaded shaft disposed through the threaded hole, the first end having a knob, and the second end having a rubber stopper.

6. The bed lifter of claim 5, wherein the screw is configured to compress the leg of the table between the rubber stopper and an inner surface of the sleeve of the connection device to secure the leg of the table at the predetermined height above the floor.

7. The bed lifter of claim 1, wherein the at least one bed lifter leg includes a plurality of bed lifter legs.

8. The bed lifter of claim 7, wherein the plurality of lifter legs includes a first pair of lifter legs and a second pair of lifter legs.

9. The bed lifter of claim 8, wherein the first pair of lifter legs and the second pair of lifter legs are connected by a pair of bridge elements.

10. The bed lifter of claim 9, wherein each of the first pair of lifter legs and the second pair of lifter legs is preformed as a stamped main body with a partial set of the bridge elements.

11. The bed lifter of claim 10, wherein the partial set of the bridge elements are bent at an angle transverse to the stamped main body of each of the first pair of lifter legs and the second pair of lifter legs.

12. The bed lifter of claim 11, wherein the partial set of the bridge elements have stepped terminal ends, with the stepped terminal ends of the partial set of bridge elements of the first pair of lifter legs interlocking with the stepped terminal ends of the partial set of bridge elements of the second pair of lifter legs to define the pair of bridge elements.

13. The bed lifter of claim 12, wherein the partial set of the bridge elements of the first pair of lifter legs is affixed to the partial set of the bridge elements of the second pair of lifter legs with connecting plates.

14. The bed lifter of claim 13, wherein the connecting plates are affixed to the bridge elements with mechanical fasteners.

15. The bed lifter of claim 13, wherein the mechanical fasteners are one of bolts, screws, and rivets.

16. A bed lifter system, comprising:
a table having a plurality of legs; and
a plurality of bed lifters, each of the bed lifters having a connection device, and a base with at least one bed lifter leg supporting the connection device,
wherein each of the plurality of legs is disposed in and received by the connection device of one of the bed lifters to selectively secure the legs of the table at a predetermined height above a floor on which the bed lifters are disposed.

17. The bed lifter system of claim 16, wherein the connection device is disposed centrally on the base, and the connection device includes a hollow sleeve and a locking mechanism, the locking mechanism adapted to secure the leg of the table within the hollow sleeve, and the hollow sleeve has a threaded hole disposed therethrough, and the locking mechanism is a screw having a threaded shaft with a first end and a second end, the threaded shaft disposed through the threaded hole, the first end having a knob, and the second end having a rubber stopper, and the screw compress one of the legs of the table between the rubber stopper and an inner surface of the sleeve of the connection device of one of the bed lifters to secure the leg of the table at the predetermined height above the base.

18. The bed lifter system of claim 16, wherein the at least one bed lifter leg includes a first pair of lifter legs and a second pair of lifter legs, the first pair of lifter legs and the second pair of lifter legs connected by a pair of bridge elements, each of the first pair of lifter legs and the second pair of lifter legs preformed as a stamped main body with a partial set of the bridge elements, the partial set of the bridge elements bent at an angle transverse to the stamped main body of each of the first pair of lifter legs and the second pair of lifter legs, the partial set of bridge elements having stepped terminal ends, with the stepped terminal ends of the partial set of bridge elements of the first pair of lifter legs interlocking with the stepped terminal ends of the partial set of bridge elements of the second pair of lifter legs to define the pair of bridge elements, the partial set of the bridge elements of the first pair of lifter legs affixed to the partial set of the bridge elements of the second pair of lifter legs with connecting plates, the connecting plates affixed to the bridge elements with mechanical fasteners.

19. A method for adjusting table height, comprising steps of:
providing a table having a plurality of legs;
providing a plurality of bed lifters, each of the bed lifters having a connection device, and a base with at least one bed lifter leg supporting the connection device;
disposing each of the legs of the table within the connection device of one of the bed lifters;
determining a predetermined height for the table; and
securing each of the legs of the table within one of the bed lifters at the predetermined height above a floor on which the bed lifters are disposed.

20. The method of claim 19, wherein the connection device is disposed centrally on the base, and the connection device includes a hollow sleeve and a locking mechanism, and the hollow sleeve has a threaded hole disposed therethrough, and the locking mechanism is a screw having a threaded shaft with a first end and a second end, the threaded shaft disposed through the threaded hole, the first end having a knob, and the second end having a rubber stopper, and
wherein the step of securing each of the legs of the table within one of the bed lifters includes compressing by the screw one of the legs of the table between the rubber stopper and an inner surface of the sleeve of the connection device of one of the bed lifters to secure the leg of the table at the predetermined height above the floor.
